(19) United States
(12) Patent Application Publication
(10) Pub. No.: US 2007/0159834 A1
(43) Pub. Date: Jul. 12, 2007

(54) Touch-control floor lamp

(76) Inventor: Chun-I Chen, Taichung (TW)

Correspondence Address: Wisam Enterprises Co., Ltd., P. O. Box No. 6-57, Junghe, Taipei, 235, TW

(21) Appl. No.: 10/759,039

(22) Filed: Jan. 20, 2004

(51) Int. Cl. F21V 21/02; F21V 23/04

(52) U.S. Cl. 362/395; 362/410

(57) ABSTRACT

A touch-control floor lamp includes a hollow supporting post extended from a seat, and a secondary light base and a main light base at an upper end of the supporting post. The invention is characterized that, the secondary light base and the main light base are both controlled by a touch-control switch and an integrated circuit. According to the aforesaid structure, the secondary light and the main light can be switched on or off in sequence by touching the supporting post, thereby individually or simultaneously illuminating the second light and the main light and facilitating brightness adjustment.

### BACKGROUND OF THE INVENTION

(a) Field of the Invention

The invention relates to a touch-control floor lamp, and more particularly, to a touch-control floor lamp, in that secondary light and a main light can be switched on or off in sequence and become lit individually or simultaneously by merely touching a supporting post, thereby facilitating a user to adjust brightness thereof.

(b) Description of the Prior Art

Prior floor lamps serving for illumination purposes are widely accepted by people for having stylish appearances as well as conveniences when put to use. Current floor lamps come in various designs and also have numerous control methods, with floors lamps controlled by touch-control switches being most extensive utilized. A touch-control floor lamp is provided with a touch core for a user to touch in order to connect or disconnect the switch, and is electrically connected with an integrated circuit in the switch. However, light bulbs of an existing floor lamp can only be lit or put out simultaneously without having adjustable brightness. Thus, inconveniences of users are incurred for either brightness of the light bulbs is too intense when switched on or the light bulbs are completely switched off.

### SUMMARY OF THE INVENTION

The primary object of the invention is to provide a touch-control floor lamp, in that a secondary light and a main light can be switched on or off in sequence and become lit individually or simultaneously by merely touching a supporting post, thereby facilitating a user to adjust brightness thereof.

To accomplish the aforesaid object, a touch-control floor lamp according to the invention comprises an extended supporting post from a seat, and a secondary light base and a main light base at an upper end of the supporting post. The invention is characterized that, the secondary light base and the main light base are both controlled by a touch-control switch having an integrated circuit therein. The integrated circuit is connected to the secondary light base and the main light base via control wires to respectively control switching on and off of the secondary light base and the main light base.

### BRIEF DESCRIPTION OF THE DRAWINGS

FIG. 1 shows an elevational view according to the invention.

FIG. 2 shows a schematic view according to the invention in connection.

FIG. 3 shows a circuit diagram of a touch-control switch according to the invention.

### DETAILED DESCRIPTION OF THE PREFERRED EMBODIMENTS

To better understand the structures, devices and characteristics of the invention, detailed descriptions shall be given with the accompanying drawings below.

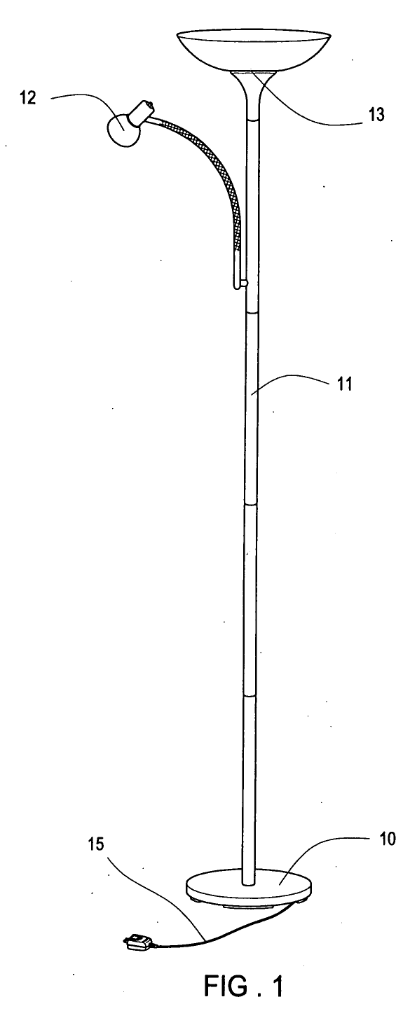

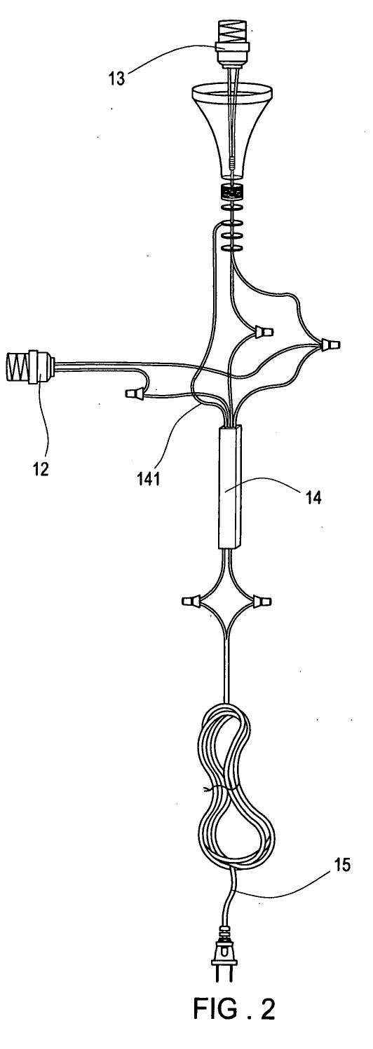

Referring to FIGS. 1 and 2, a touch-control floor lamp according to the invention comprises a seat 10, a hollow supporting post 11 extended upward from the seat 10, and a secondary light base 12 and a main light base 13 at an upper end of the supporting post 11, with the secondary light base 12 and the main light base 13 disposed with light bulbs.

The invention is characterized that, the secondary light base 12 and the main light base 13 are both controlled by a touch-control switch 14 having an integrated circuit therein. The integrated circuit has double-loop control wires that are respectively connected to the secondary light base 12 and the main light base 13, so as to switch on or switch off the light bulbs at the secondary light base 12 and the main light base 13 in sequence. The touch-control switch 14 is located in the hollow structure of the supporting post 11, and is connected with the supporting post 11 via a touch-control wire 141 for electrically connecting the supporting post 11.

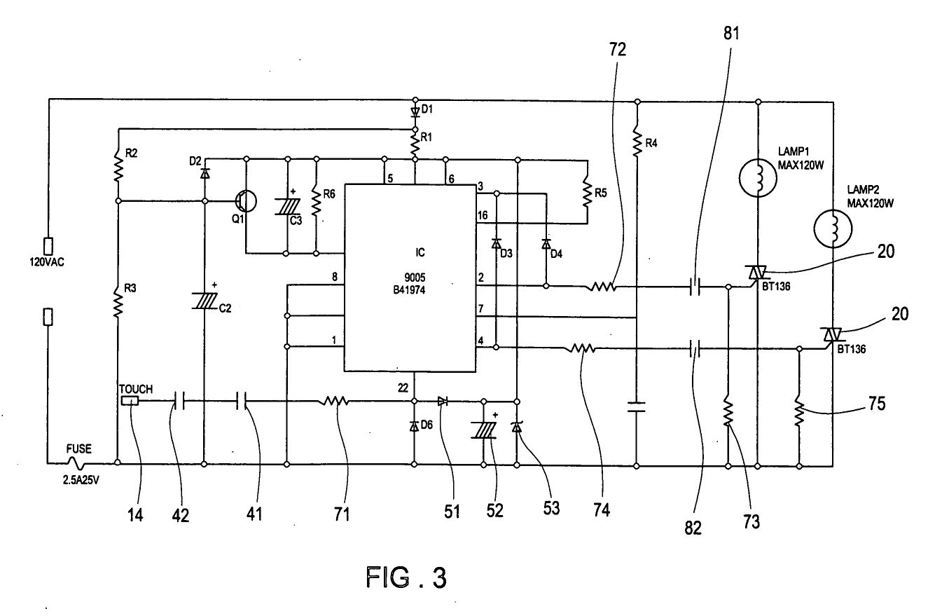

Referring to FIG. 3, the integrated circuit in the touch-control switch 14 is connected with the touch-control wire 141 via a touch-control circuit consisted of capacitors 41 and 42 and a resistor 71 connected is series.

According to the aforesaid structure, to put the touch-control floor lamp according to the invention to use, power is first conducted via an externally extended power wire 15. An outer surface of the supporting post 11 is touched by a hand of a user, and signals from a position being touched are inputted. The signals are entered via the touch-control wire 141 to pass through the touch-control circuit consisted the capacitors 41 and 42 and the resistor 71 connected in series, and are forwarded to the integrated circuit via a trigger end 22 of the integrated circuit (B41974) for further analysis. The trigger end 22 is also connected to a circuit formed by a diode 51, a capacitor 52 and a voltage regulating diode 53. After the signals are processed and analyzed, the integrated circuit outputs corresponding commands. An output voltage then is outputted from an output end, and passed through an amplifying circuit consisted of resistors 72 and 72, a capacitor 81 and a transistor 20 to reach the secondary light base 12, thereby illuminating the light bulb at the secondary light base 12. At this point, the light bulb at the main light base 13 remains switched off. When the light bulb at the secondary light base 12 is illuminated, the outer surface of the supporting post 11 is again touched, so that the integrated circuit (B41974) again receives touch-control signals for further analysis. A corresponding voltage is outputted from an output end 4, and is passed through an amplifying circuit consisted of resistors 74 and 75, a capacitor 82 and a transistor 30 to reach the main light base 13, such that a voltage is acquired by the light bulb at the main light base 13 to illuminate simultaneously with the light bulb at the secondary light base 12. When the light bulb at the secondary light bulb 13 is lit, supposed the supporting post 11 is touched; that is, the touch-control switch 14 is touched; signals are inputted into the integrated circuit (B41974) to have the integrated circuit (B41974) command switching off the power of the secondary light base 12 to leave only the light bulb at the main light base 13 illuminated. Supposed the touch-control switch 14 is again touched at this point, the light bulb at the main light base 13 is put out for completely switching off the floor lamp. By repeated touching, the light bulbs at the secondary light base 12 and the main light base 13 can be switched on and off in sequence. Thus, the light bulbs are enabled to illuminate individually or simultaneously, so as to facilitate a user to adjust brightness of the floor lamp.

Conclusive from the above descriptions, the touch-control lamp according to the invention indeed accomplishes brightness adjustment effects using touching means. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A touch-control floor lamp comprising a seat, a hollow supporting post extended from the seat, and a secondary light base and a main light base at an upper end of the supporting post, with the secondary light base and the main light base disposed with light bulbs; and being characterized that, the secondary light base and the main light base are both controlled by a touch-control switch having an integrated circuit therein, and the integrated circuit is connected to the secondary light base and the main light base via double-loop control wires.

2. The touch-control floor lamp according to claim 1, wherein the touch-control switch is located in the hollow structure of the supporting post, and is connected with the supporting post via a touch-control wire for electrically connecting the supporting post, thereby switching on and off the light bulbs at the secondary light base and the main light base in a secondary-to-main sequence.
